(19) United States
(12) Patent Application Publication
(10) Pub. No.: US 2018/0048890 A1
(43) Pub. Date: Feb. 15, 2018

(54) METHOD AND DEVICE FOR ENCODING AND DECODING VIDEO SIGNAL BY USING IMPROVED PREDICTION FILTER

(71) Applicant: LG Electronics Inc., Seoul (KR)

(72) Inventors: Chulkeun KIM, Seoul (KR); Junghak NAM, Seoul (KR); Seungwook PARK, Seoul (KR); Sehoon YEA, Seoul (KR)

(21) Appl. No.: 15/555,424

(22) PCT Filed: Feb. 2, 2016
(86) PCT No.: PCT/KR2016/001105

§ 371 Date: Sep. 1, 2017

Related U.S. Application Data
(60) Provisional application No. 62/127,229, filed on Mar. 2, 2015.

(51) Int. Cl. H04N 19/117; H04N 19/46

(52) U.S. Cl. CPC H04N 19/117; H04N 19/46; H04N 19/503

(57) ABSTRACT

The present invention provides a method for decoding a video signal. The method includes: obtaining filtering flag information indicating whether to perform filtering for a target unit; obtaining a filter parameter based on the filtering flag information, the filter parameter including at least one of a base filter kernel and a modulation weight; and performing filtering for the target unit using the filter parameter, wherein the filter parameter corresponds to a temporal filter parameter or a spatial filter parameter, and the temporal filter parameter is used to minimize the difference between an original image and a reference image, and the spatial filter parameter is used to minimize the difference between the original image and a reconstructed image.

### TECHNICAL FIELD

The present invention relates to a method and apparatus for encoding and decoding a video signal, and more particularly, to a technique for efficiently predicting a target region.

### BACKGROUND ART

Compression coding refers to a series of signal processing technologies for transmitting digitalized information through a communication line or storing the digitalized information in a form appropriate for a storage medium. Media such as video, an image, voice, and the like, may be the subject to compression coding, and in particular, a technology for performing compression coding on video is called video compression.

Next-generation video content is expected to feature high spatial resolution, a high frame rate, and high dimensionality of scene representation. The processing of such content will bring about a significant increase in message storage, a memory access rate, and processing power.

Thus, a coding tool for effectively processing next-generation video content is required to be designed.

Particularly, many filters such as a deblocking filter, SAO, and ALF are present in a codec, so there is a need to redesign filters performing a similar function according to purpose. Accordingly, our aim is to improve coding efficiency by designing a simpler codec through filter design.

### DISCLOSURE

### Technical Problem

The present invention proposes a method for improving coding efficiency through prediction filter design.

The present invention proposes a method for improving prediction performance and the quality of a reconstructed frame through prediction filter design.

The present invention proposes a method for designing filters performing a similar function into a single new filter based on their function.

The present invention proposes a method for signaling information related to a newly designed prediction filter.

### Technical Solution

An embodiment of the present invention proposes a method for designing a coding tool for high-efficiency compression.

Furthermore, an embodiment of the present invention provides a more efficient prediction method in a prediction process.

Furthermore, an embodiment of the present invention provides a prediction filter design method for improving coding efficiency.

Furthermore, an embodiment of the present invention provides a method for designing a prediction filter applied to pictures for intra-screen prediction or inter-screen prediction in a process of encoding or decoding a video signal.

Furthermore, an embodiment of the present invention provides a method for better predicting a target region.

### Advantageous Effects

The present invention may improve prediction performance, the quality of a reconstructed frame, and, moreover, coding efficiency through prediction filter design.

Furthermore, the present invention allows for a simpler codec design by proposing a method for designing filters performing a similar function into a single new filter based on their function.

### DESCRIPTION OF DRAWINGS

FIG. 1 is a schematic block diagram of an encoder encoding a video signal according to an embodiment to which the present disclosure is applied.

FIG. 2 is a schematic block diagram of a decoder decoding a video signal according to an embodiment to which the present disclosure is applied.

FIG. 3 is a schematic internal block diagram of an in-loop filtering unit according to an embodiment to which the present disclosure is applied.

FIG. 4 is a view illustrating a partition structure of a coding unit according to an embodiment to which the present disclosure is applied.

FIG. 5 is a schematic block diagram of an encoder performing adaptive prediction filtering according to another embodiment to which the present disclosure is applied.

FIG. 6 is a schematic block diagram of a decoder performing adaptive prediction filtering according to an embodiment to which the present disclosure is applied.

FIG. 7 is a schematic internal block diagram of a prediction filtering unit according to an embodiment to which the present disclosure is applied.

FIG. 8 is a view illustrating a spatial filter parameter and a temporal filter parameter according to an embodiment to which the present disclosure is applied.

FIG. 9 shows a method of performing prediction filtering based on a spatial filter parameter or temporal filter parameter according to an embodiment to which the present disclosure is applied.

FIG. 10 shows a syntax structure for defining a filter parameter based on filtering flag information at the sequence level according to an embodiment to which the present disclosure is applied.

FIG. 11 shows a syntax structure for defining a filter parameter at the slice level according to an embodiment to which the present disclosure is applied.

FIG. 12 shows a syntax structure for defining a filter parameter based on filtering flag information for each PU (prediction unit) according to an embodiment to which the present disclosure is applied.

FIG. 13 shows a syntax structure for defining a filter parameter according to an embodiment to which the present disclosure is applied.

### BEST MODE FOR INVENTION

The present invention provides a method for decoding a video signal, including: obtaining filtering flag information indicating whether to perform filtering for a target unit; obtaining a filter parameter based on the filtering flag information, the filter parameter including at least one of a base filter kernel and a modulation weight; and performing filtering for the target unit using the filter parameter, wherein the filter parameter corresponds to a temporal filter parameter or a spatial filter parameter, and the temporal filter parameter is used to minimize the difference between an original image and a reference image, and the spatial filter parameter is used to minimize the difference between the original image and a reconstructed image.

Furthermore, in the present invention, the filtering flag information includes at least one of a temporal filtering flag and a spatial filtering flag, wherein the filter parameter corresponds to the filtering flag information.

Furthermore, in the present invention, when the filtering flag information indicates the temporal filtering flag, the filter parameter indicates the temporal filter parameter, and a filtered target unit is used as a prediction signal for inter-prediction.

Furthermore, in the present invention, when the filtering flag information indicates the spatial filtering flag, the filter parameter indicates the spatial filter parameter, and a filtered target unit is stored in a buffer.

Furthermore, in the present invention, the method further comprises obtaining a base parameter based on the filtering flag information, wherein the filtering flag information is obtained from a sequence parameter set, and the base parameter includes at least one of number information of a base filter kernel and number information of a modulation weight.

Furthermore, in the present invention, wherein the base filter kernel is a predetermined value in the decoder.

Furthermore, in the present invention, the filtering flag information is obtained from at least one of a sequence parameter set, a picture parameter set, a slice, a coding unit, a prediction unit, or a block.

Furthermore, the present invention provides an apparatus for decoding a video signal, comprising: a filter type determination unit that obtains filtering flag information indicating whether to perform filtering for a target unit; a filter parameter acquisition unit that obtains a filter parameter based on the filtering flag information; and a filtering unit that performs filtering for the target unit using the filter parameter, wherein the filter parameter includes at least one of a base filter kernel and a modulation weight, the filter parameter corresponds to a temporal filter parameter or a spatial filter parameter, and the temporal filter parameter is used to minimize the difference between an original image and a reference image, and the spatial filter parameter is used to minimize the difference between the original image and a reconstructed image.

Furthermore, in the present invention, the parameter acquisition unit obtains a base parameter based on the filtering flag information, wherein the filtering flag information is obtained from a sequence parameter set, and the base parameter includes at least one of number information of a base filter kernel and number information of a modulation weight.

### MODE FOR INVENTION

Hereinafter, exemplary elements and operations in accordance with embodiments of the present invention are described with reference to the accompanying drawings. The elements and operations of the present invention that are described with reference to the drawings illustrate only embodiments, which do not limit the technical spirit of the present invention and core constructions and operations thereof.

Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be construed as being based on only the name of a term used in a corresponding description of this specification and that the present invention should be construed by checking even the meaning of a corresponding term.

Furthermore, terms used in this specification are common terms selected to describe the invention, but may be replaced with other terms for more appropriate analyses if other terms having similar meanings are present. For example, a signal, data, a sample, a picture, a frame, and a block may be properly replaced and interpreted in each coding process. And, partitioning, decomposition, splitting, and division may be properly replaced and interpreted in each coding process.

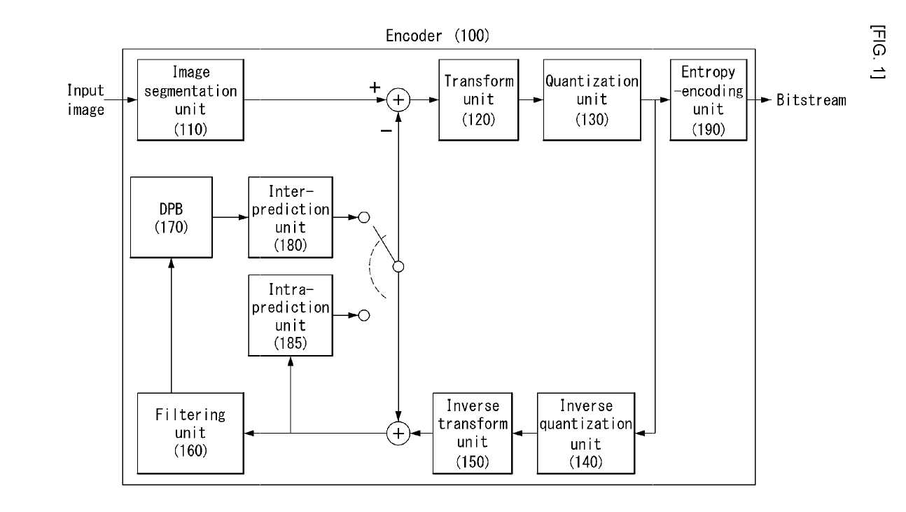

FIG. 1 shows a schematic block diagram of an encoder for encoding a video signal, in accordance with one embodiment of the present invention.

Referring to FIG. 1, the encoder 100 may include an image segmentation unit 110, a transform unit 120, a quantization unit 130, an inverse quantization unit 140, an inverse transform unit 150, an in-loop filtering unit 160, a decoded picture buffer (DPB) 170, a prediction filtering unit 175, a prediction unit 180, and an entropy-encoding unit 190. The prediction unit 180 may include an inter-prediction unit 181 and an intra-prediction unit 185.

The image segmentation unit 110 may divide an input image (or, a picture, a frame) input to the encoder 100 into one or more process units. For example, the process unit may be a coding tree unit (CTU), a coding unit (CU), a prediction unit (PU), or a transform unit (TU).

However, the terms are used only for convenience of illustration of the present disclosure. The present invention is not limited to the definitions of the terms. In this specification, for convenience of illustration, the term “coding unit” or “target unit” is employed as a unit used in a process of encoding or decoding a video signal. However, the present invention is not limited thereto. Another process unit may be appropriately selected based on contents of the present disclosure.

The encoder 100 may generate a residual signal by subtracting a prediction signal output from the inter-prediction unit 181 or intra prediction unit 185 from the input image signal. The generated residual signal may be transmitted to the transform unit 120.

The transform unit 120 may apply a transform technique to the residual signal to produce a transform coefficient. The transform process may be applied to a pixel block having the same size of a square, or to a block of a variable size other than a square.

The quantization unit 130 may quantize the transform coefficient and transmits the quantized coefficient to the entropy-encoding unit 190. The entropy-encoding unit 190 may entropy-code the quantized signal and then output the entropy-coded signal as bit streams.

The quantized signal output from the quantization unit 130 may be used to generate a prediction signal. For example, the quantized signal may be subjected to an inverse quantization and an inverse transform via the inverse quantization unit 140 and the inverse transform unit 150 in the loop respectively to reconstruct a residual signal. The reconstructed residual signal may be added to the prediction signal output from the inter-prediction unit 181 or intra-prediction unit 185 to generate a reconstructed signal.

Meanwhile, in the compression process, adjacent blocks may be quantized by different quantization parameters, so that deterioration of the block boundary may occur. This phenomenon is called blocking artifacts. This is one of important factors for evaluating image quality. A filtering process may be performed to reduce such deterioration. Using the filtering process, the blocking deterioration may be eliminated, and, at the same time, an error of a current picture may be reduced, thereby improving the image quality.

The in-loop filtering unit 160 applies filtering to a reconstructed signal and outputs it to a reproducing device or transmits it to the decoded picture buffer 170. That is, the in-loop filtering unit 160 may perform a filtering process for minimizing the difference between an original image and a reconstructed image.

A filtered signal transmitted to the decoded picture buffer 170 may be transmitted to the prediction filtering unit 175 and re-filtered to improve prediction performance. The prediction filtering unit 175 may perform a filtering process for minimizing the difference between an original image and a reference image. For example, the prediction filtering unit 175 may perform filtering using a Wiener filter.

A signal filtered through the prediction filtering unit 175 may be transmitted to the prediction unit 180 and used to generate a prediction signal. For example, the signal filtered through the prediction filtering unit 175 may be used as a reference picture by the inter-prediction unit 181. In this way, coding efficiency may be improved by using a filtered picture as a reference picture in an inter-screen prediction mode. Although the prediction filtering unit 175 is illustrated as a separate unit from the prediction unit 180, this is merely an embodiment and the prediction filtering unit 175 may be located within the prediction unit 180 or configured together with other units.

The decoded picture buffer 170 may store an in-loop filtered picture or prediction filtered picture to store them as a reference picture in the inter-prediction unit 181.

The inter-prediction unit 181 performs temporal prediction and/or spatial prediction to eliminate temporal redundancy and/or spatial redundancy by referring to a reconstructed picture or a picture filtered through the prediction filtering unit 175. Here, the reference picture used for performing prediction is a transformed signal that has passed through quantization and inverse quantization for each block previously at the time of coding/decoding, so blocking artifacts or ringing artifacts may exist.

Accordingly, in order to solve performance degradation caused by such signal discontinuity or quantization, the inter-prediction unit 181 may interpolate an inter-pixel signal for each subpixel by using a lowpass filter. Here, a subpixel refers to a virtual pixel generated using an interpolation filter, and an integer pixel refers to an actual pixel that exists in a reconstructed picture. Methods of interpolation may include linear interpolation, a bi-linear interpolation, Wiener filter, etc.

The interpolation filter may be used for a reconstructed picture to improve prediction accuracy. For example, the inter-prediction unit 181 may generate an interpolated pixel by applying the interpolation filter to an integer pixel, and may perform prediction by using an interpolated block consisting of interpolated pixels as a prediction block.

The intra-prediction unit 185 may predict the current block by referring to samples adjacent to a block for which coding is currently to be performed. The intra-prediction unit 185 may perform the following process in order to perform intra-prediction. First, a reference sample required to generate a prediction signal may be prepared. Then, a prediction signal may be generated using the prepared reference sample. Afterwards, prediction modes are coded. In this instance, the reference sample may be prepared through reference sample padding and/or reference sample filtering. The reference sample may have a quantization error since it has undergone prediction and reconstruction processes. Accordingly, in order to reduce such errors, a reference sample filtering process may be performed for each prediction mode used for intra-prediction.

A prediction signal generated by the inter-prediction unit 181 or the intra-prediction unit 185 may be used to generate a reconstruction signal or a residual signal.

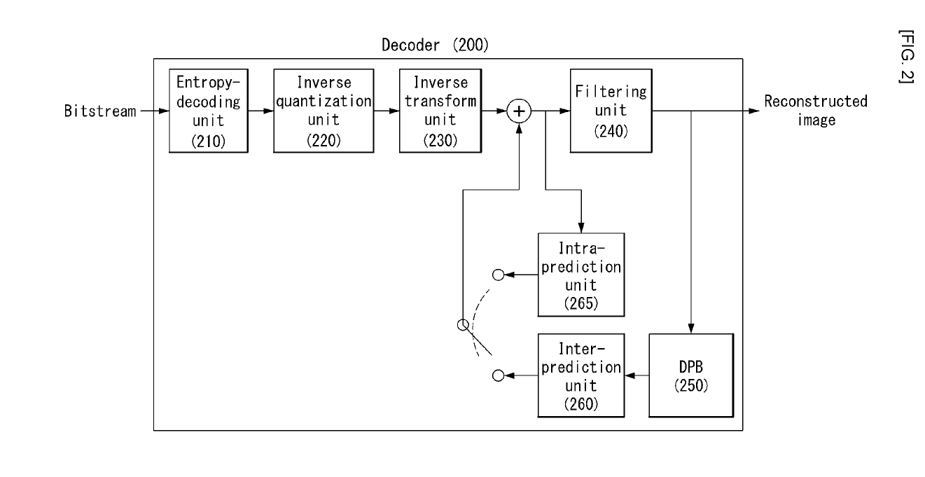

FIG. 2 shows a schematic block diagram of a decoder for decoding a video signal, in accordance with one embodiment of the present invention.

Referring to FIG. 2, the decoder 200 may include an entropy decoding unit 210, an inverse quantization unit 220, an inverse transform unit 230, an in-loop filtering unit 240, a decoded picture buffer (DPB) 250, and a prediction unit 260. The prediction unit 260 may include an inter-prediction unit 261 and an intra-prediction unit 265.

A reconstructed video signal output from the decoder 200 may be played using a playback device.

The decoder 200 may receive the signal output from the encoder as shown in FIG. 1. The received signal may be entropy-decoded via the entropy-decoding unit 210.

The inverse quantization unit 220 may obtain a transform coefficient from the entropy-decoded signal using quantization step size information.

The inverse transform unit 230 may inverse-transform the transform coefficient to obtain a residual signal.

A reconstructed signal may be generated by adding the obtained residual signal to the prediction signal output from the inter-prediction unit 260 or the intra-prediction unit 265.

The in-loop filtering unit 240 may perform filtering using a filter parameter, and a filtered reconstruction signal may be output to a reproducing device or stored in the decoded picture buffer 250. That is, the in-loop filtering unit 240 may perform a filtering process for minimizing the difference between an original image and a reconstructed image. In this case, the filter parameter may be transmitted from the encoder, or may be derived from other coding information.

A filtered signal transmitted to the decoded picture buffer 250 may be transmitted to the prediction filtering unit 255 and re-filtered to improve prediction performance. The prediction filtering unit 255 may perform a filtering process for minimizing the difference between an original image and a reference image. For example, the prediction filtering unit 255 may perform filtering using a Wiener filter.

A signal filtered through the prediction filtering unit 255 may be transmitted to the prediction unit 260 and used to generate a prediction signal. For example, the signal filtered through the prediction filtering unit 255 may be used as a reference picture by the inter-prediction unit 261. In this way, coding efficiency may be improved by using a filtered picture as a reference picture in the inter-screen prediction mode. Although the prediction filtering unit 255 is illustrated as a separate unit from the prediction unit 260, this is merely an embodiment and the prediction filtering unit 255 may be located within the prediction unit 260 or configured together with other units.

The decoded picture buffer 250 may store an in-loop filtered picture or prediction filtered picture to store them as a reference picture in the inter-prediction unit 261.

In this specification, the exemplary embodiments explained with respect to the in-loop filtering unit 160, inter-prediction unit 181, and intra-prediction unit 185 of the encoder 100 may equally apply to the in-loop filtering unit 240, inter-prediction unit 261, and intra-prediction unit 265 of the decoder 200.

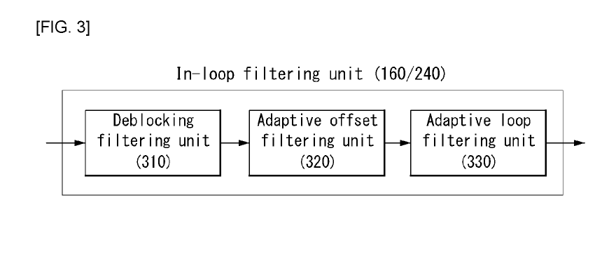

FIG. 3 is a schematic internal block diagram of an in-loop filtering unit according to an embodiment to which the present disclosure is applied.

The in-loop filtering unit may include at least one of a deblocking filtering unit 310, an adaptive offset filtering unit 320, and an adaptive loop filtering unit 330.

The in-loop filtering unit may apply filtering to a reconstructed picture and output it to a reproducing device or store it in a buffer to use it as a reference picture in an inter-prediction mode.

The deblocking filtering unit 310 may perform a function of improving distortion occurring at a boundary of a reconstructed picture. For example, it may improve blocking deterioration occurring at a boundary of a prediction unit or transform unit. First, the deblocking filtering unit 310 may check for a discontinuity in reconstructed pixel values at block boundaries, and if blocking deterioration occurs, it may perform deblocking filtering at the corresponding edge boundary. For example, it is determined whether the block boundary is an 8×8 block boundary and at the same time a boundary of a prediction unit or transform unit, and the boundary strength value may be calculated based on the determination. Whether to perform filtering or not may be determined based on the boundary strength value. In this case, a filter parameter may be used as well.

The adaptive offset filtering unit 320 may perform a function of minimizing the error between a reconstructed image and an original image by adding an offset to reconstructed pixels. Here, the reconstructed image may refer to a deblocking filtered image. The encoder may calculate an offset parameter for correcting for the error between the reconstructed image and the original image and transmit it to the decoder, and the decoder may entropy-decode the transmitted offset parameter and then perform filtering for each pixel based on that offset parameter.

The adaptive loop filtering unit 330 may calculate an optimum coefficient for minimizing the error between the original image and the reconstructed image and perform filtering. The encoder may derive a filter coefficient for minimizing the error between the original image and the reconstructed image, and adaptively transmit to the decoder information about whether to apply adaptive loop filtering for each block and the filter coefficient. The decoder may perform filtering based on the transmitted information about whether to apply adaptive loop filtering and the transmitted filter coefficient.

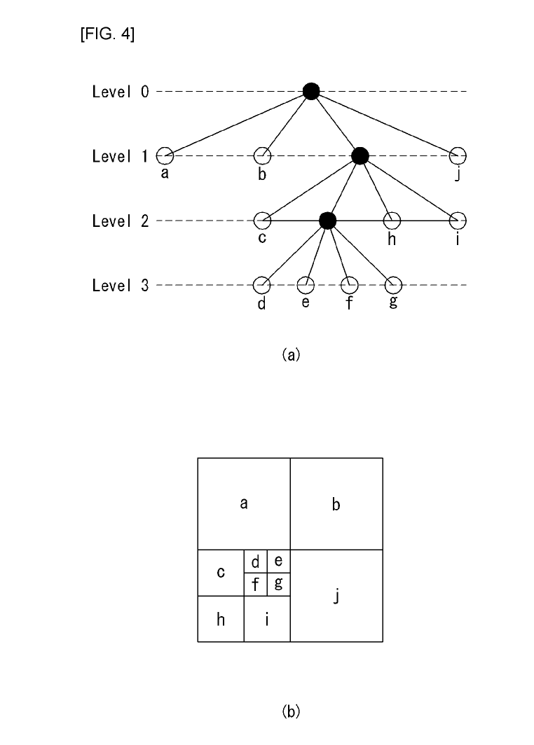

FIG. 4 is a view illustrating a partition structure of a coding unit according to an embodiment to which the present disclosure is applied.

An encoder may partition an image (or picture) by rectangular coding tree units (CTUs). Also, the encoder sequentially encodes the CTUs one after another in raster scan order.

For example, a size of the CTU may be determined to any one of 64×64, 32×32, and 16×16, but the present disclosure is not limited thereto. The encoder may selectively use a size of the CTU depending on resolution or characteristics of an input image. The CTU may include a coding tree block (CTB) regarding a luma component and a CTB regarding two chroma components corresponding thereto.

One CTU may be decomposed into a quadtree (QT) structure. For example, one CTU may be partitioned into four equal-sized square units and having each side whose length is halved each time. Decomposition according to the QT structure may be performed recursively.

Referring to FIG. 4, a root node of the QT may be related to the CTU. The QT may be divided until it reaches a leaf node, and here, the leaf node may be termed a coding unit (CU).

The CU may be a basic unit for coding based on which processing an input image, for example, intra/inter prediction is carried out. The CU may include a coding block (CB) regarding a luma component and a CB regarding two chroma components corresponding thereto. For example, a size of the CU may be determined to any one of 64×64, 32×32, 16×16, and 8×8, but the present disclosure is not limited thereto and the size of the CPU may be increased or diversified in the case of a high definition image.

Referring to FIG. 4, the CTU corresponds to a root node and has a smallest depth (i.e., level 0). The CTU may not be divided depending on characteristics of an input image and, in this case, the CTU corresponds to a CU.

The CTU may be decomposed into a QT form and, as a result, lower nodes having a depth of level 1 may be generated. A node (i.e., a leaf node) which is not partitioned any further, among the lower nodes having the depth of level 1, corresponds to a CU. For example, in FIG. 4(b), CU(a), CU(b), and CU(j) respectively corresponding to nodes a, b, and j have been once partitioned and have the depth of level 1.

At least one of the nodes having the depth of level 1 may be divided again into the QT form. Also, a node (i.e., a leaf node) which is not divided any further among the lower nodes having a depth of level 2 corresponds to a CU. For example, in FIG. 4(b), CU(c), CU(h), and CU(i) respectively corresponding to nodes c, h, and l have been divided twice and have the depth of level 2.

Also, at least one of the nodes having the depth of level 2 may be divided again in the QT form. Also, a node (leaf node) which is not divided any further among the lower nodes having a depth of level 3 corresponds to a CU. For example, in FIG. 4(b), CU(d), CU(e), CU(f), and CU(g) respectively corresponding to nodes d, e, f, and g have been divided three times and have the depth of level 3.

In the encoder, a largest size or a smallest size of a CPU may be determined according to characteristics (e.g., resolution) of a video image or in consideration of efficiency of coding. Also, information regarding the determined largest size or smallest size of the CU or information deriving the same may be included in a bit stream. A CPU having a largest size may be termed a largest coding unit (LCU) and a CU having a smallest size may be termed a smallest coding unit (SCU).

Also, the CU having a tree structure may be hierarchically divided with predetermined largest depth information (or largest level information). Also, each of the divided CUs may have depth information. Since the depth information represents the number by which a CU has been divided and/or a degree to which the CU has been divided, the depth information may include information regarding a size of the CU.

Since the LCU is divided into the QT form, a size of the SCU may be obtained using a size of the LCU and largest depth information. Or, conversely, a size of the LCU may be obtained using the size of the SCU and largest depth information of a tree.

Regarding one CU, information representing whether the corresponding CU is partitioned may be delivered to the decoder. For example, the information may be defined as a split flag and represented by a syntax element “split_cu_flag”. The split flag may be included in every CU except for the SCU. For example, if the value of the split flag is ‘1’, the corresponding CU is partitioned again into four CUs, while if the split flag is ‘0’, the corresponding CU is not partitioned further, but a coding process with respect to the corresponding CU may be carried out.

Although the embodiment of FIG. 4 has been described with respect to a partitioning process of a CU, the QT structure may also be applied to the transform unit (TU) which is a basic unit carrying out transformation.

A TU may be partitioned hierarchically into a quadtree structure from a CU to be coded. For example, the CU may correspond to a root node of a tree for the TU.

Since the TU may be partitioned into a QT structure, the TU partitioned from the CU may be partitioned into smaller TUs. For example, the size of the TU may be determined by any one of 32×32, 16×16, 8×8, and 4×4. However, the present invention is not limited thereto and, in the case of a high definition image, the TU size may be larger or diversified.

For each TU, information regarding whether the corresponding TU is partitioned may be delivered to the decoder. For example, the information may be defined as a split transform flag and represented as a syntax element “split_transform_flag”.

The split transform flag may be included in all of the TUs except for a TU having a smallest size. For example, when the value of the split transform flag is ‘1’, the corresponding CU is partitioned again into four TUs, and when the split transform flag is ‘0’, the corresponding TU is not partitioned further.

As described above, a CU is a basic coding unit, based on which intra- or inter-prediction is carried out. In order to more effectively code an input image, a CU can be decomposed into prediction units (PUs).

A PU is a basic unit for generating a prediction block; prediction blocks may be generated differently in units of PUs even within one CU. A PU may be partitioned differently according to whether an intra-prediction mode or an inter-prediction mode is used as a coding mode of the CU to which the PU belongs.

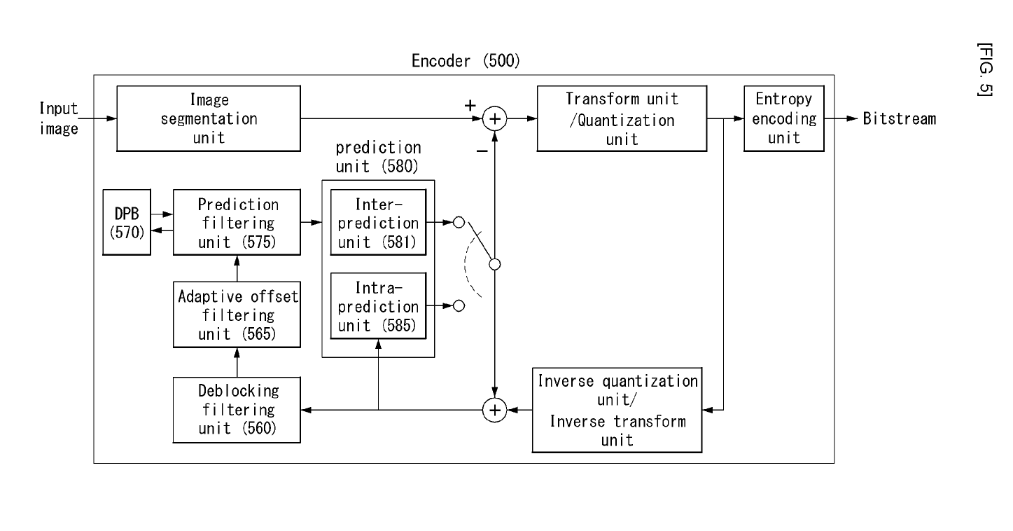

FIG. 5 is a schematic block diagram of an encoder performing adaptive prediction filtering according to another embodiment to which the present disclosure is applied.

Referring to FIG. 5, the encoder 500 may include an image segmentation unit, a transform unit, a quantization unit, an inverse quantization unit, an inverse transform unit, a deblocking filtering unit 560, an adaptive offset filtering unit 565, a decoded picture buffer (DPB) 570, a prediction filtering unit 575, a prediction unit 580, and an entropy-encoding unit. The prediction unit 580 may include an inter-prediction unit 581 and an intra-prediction unit 585. The functions of the units explained with reference to FIG. 1 may also apply to the units in the encoder 500 to be explained with reference to FIG. 5, so redundant descriptions will be omitted.

Many filters may be present in the encoder. Examples of these filters may include a deblocking filter, an adaptive offset filter, a prediction filter, an adaptive loop filter, etc. However, some of the aforementioned filters may perform a similar function. Accordingly, there is a need to reuse filters performing a similar function according to purpose.

In an embodiment to which the present disclosure is applied, the encoder may be configured such that the prediction filter is used for the purpose of improving the quality of a reconstructed image, as well as for inter-prediction. In this case, the prediction filter may replace the function of the adaptive offset filter or adaptive loop filter. Through the present invention, when performing inter-prediction, the prediction filter may be used for improving the quality of a reconstructed image, as well as for improving a prediction value. Accordingly, the encoder may be designed in a simpler manner, and coding efficiency may be improved.

A picture obtained through the inverse transform unit may be input into a buffer after a loop-filtering process. In this instance, the difference between an input image and a reconstructed image may be minimized through the loop-filtering process. The image stored in the buffer may be used as a reference image for inter-prediction. Hereupon, a filtering process for minimizing the difference with the current image to be coded may be performed. For example, this may be performed by the prediction filtering unit 575. A CPF (condensed prediction filter) or a Wiener filter may be used as the prediction filtering unit 575. The block diagram of FIG. 5 is merely an embodiment, and the prediction filtering unit 575 may include a loop-filtering process. For example, the prediction filtering unit 575 may include the deblocking filtering unit 560 and the adaptive offset filtering unit 565.

The description given with reference to FIG. 1 may apply to the deblocking filtering unit 560 and the adaptive offset filtering unit 565.

The prediction filtering unit 575 may perform filtering for making a more accurate prediction and may also perform filtering for improving the quality of a reconstructed image.

The prediction filtering unit 575 may use a filter represented by the following Equation 1:

F=GC [Equation 1]

where G and C denote filter parameters; specifically, G denotes a base filter kernel, and C denotes a modulation weight.

In this specification, the modulation weight may be called a filter parameter, and a temporal modulation weight may be called a temporal filter parameter, and a spatial modulation weight may be called a spatial filter parameter. Accordingly, in this specification, a filter parameter may refer to at least one of a base filter kernel and a modulation weight. Further, the modulation weight may refer to at least one of a temporal modulation weight and a spatial modulation weight.

The base filter kernel G may be information already known to the encoder and the decoder. However, the present invention is not limited to this, and, for example, the base filter kernel G for each unit configured in the encoder may be calculated and transmitted to the decoder. Alternatively, the base filter kernel G for each unit configured in the encoder and decoder may be derived.

The modulation weight C may include at least one of a temporal modulation weight and a spatial modulation weight.

The temporal modulation weight may refer to a filter parameter used for filtering a predicted image for inter-prediction. For example, the temporal modulation weight may refer to weight information for minimizing the difference between an original image and a reference image, and may be represented by C_temporal.

The spatial modulation weight may refer to a filter parameter used for filtering a reconstructed image to improve the quality of the reconstructed image. For example, the spatial modulation weight may refer to weight information for minimizing the difference between an original image and a reconstructed image, and may be represented by C_spatial.

The prediction filtering unit 575 may perform adaptive filtering by calculating an appropriate modulation weight according to purpose and applying it to the base filter kernel G.

Accordingly, the prediction filtering unit 575 may need to determine first whether to perform temporal filtering or spatial filtering. For example, whether the prediction filtering unit 575 will perform temporal filtering or spatial filtering may be defined by flag information.

When the prediction filtering unit 575 performs temporal filtering, a temporal filter parameter for temporal filtering may be defined. For example, the temporal filter parameter may include at least one of a base parameter and a filter parameter. In a specific example, the base parameter may include at least one of the number of filters and the number of weights, and the filter parameter may include at least one of a base filter kernel and a temporal modulation weight.

Through the temporal filtering, the prediction filtering unit 575 may generate a more accurate prediction signal. The generated prediction signal may be transmitted to the prediction unit 580 and used for inter-prediction.

Meanwhile, when the prediction filtering unit 575 performs spatial filtering, a spatial filter parameter for spatial filtering may be defined. For example, the spatial filter parameter may include at least one of a base parameter and a filter parameter. In a specific example, the base parameter may include at least one of the number of filters and the number of weights, and the filter parameter may include at least one of a base filter kernel and a spatial modulation weight.

Through the spatial filtering, the prediction filtering unit 575 may minimize the difference between a loop-filtered reconstructed image and an original image. That is, the prediction filtering unit 575 may perform filtering on a reconstructed image based on a spatial filter parameter, and the filtered reconstructed image may be stored in the DPB. The image thus stored in the DPB may be used for inter-prediction, and, further, temporal filtering may be applied to that image through the prediction filtering unit 575.

In another embodiment to which the present disclosure is applied, at least one of the base parameter and filter parameter for the temporal filtering or spatial filtering may be defined at the level of at least one of an SPS (sequence parameter set), a PPS (picture parameter set), a slice, a CU (coding unit), a PU (prediction unit), a block, a polygon, and a process unit.

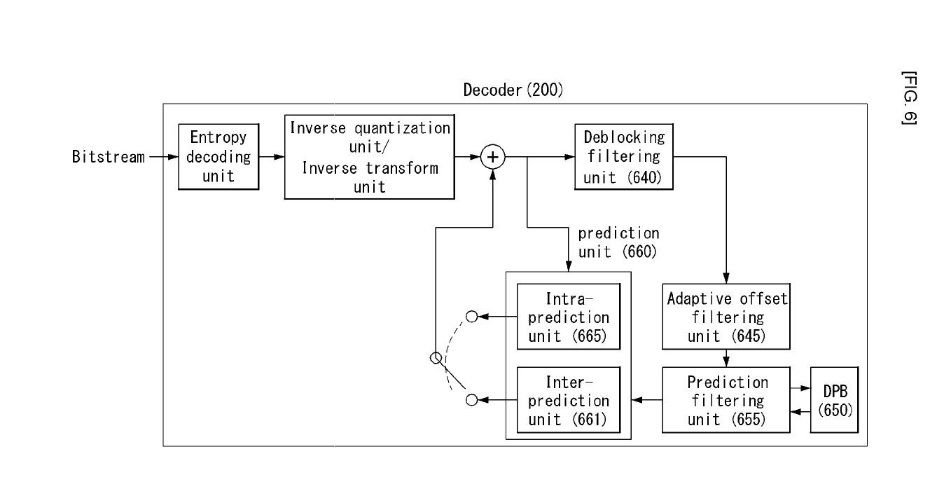

FIG. 6 is a schematic block diagram of a decoder performing adaptive prediction filtering according to an embodiment to which the present disclosure is applied.

Referring to FIG. 6, the decoder 600 may include an entropy decoding unit, an inverse quantization unit, an inverse transform unit, a deblocking filtering unit 640, an adaptive offset filtering unit 645, a decoded picture buffer (DPB) 650, and a prediction unit 660. The prediction unit 660 may include an inter-prediction unit 661 and an intra-prediction unit 665. Also, a reconstructed video signal output from the decoder 200 may be played using a playback device.

The functions of the units explained with reference to FIG. 2 may apply to the units in the decoder 600 to be explained with reference to FIG. 6, so redundant descriptions will be omitted.

Like in the encoder, many filters may be present in the decoder. Examples of these filters may include a deblocking filter, an adaptive offset filter, a prediction filter, an adaptive loop filter, etc. However, some of the aforementioned filters may perform a similar function. Accordingly, there is a need to reuse filters performing a similar function according to purpose.

In an embodiment to which the present disclosure is applied, the decoder may be configured such that the prediction filter is used for the purpose of improving the quality of a reconstructed image, as well as for inter-prediction. In this case, the prediction filter may replace the function of the adaptive offset filter or adaptive loop filter. Through the present invention, when performing inter-prediction, the prediction filter may be used for improving the quality of a reconstructed image, as well as for improving a prediction value. Accordingly, the decoder may be designed in a simpler manner, and coding efficiency may be improved.

A residual image obtained through the inverse transform unit may combine with a predicted image to create a reconstructed image, and the reconstructed image may pass through a loop-filtering process. The description given with reference to FIGS. 1, 2, and 5 may apply to the deblocking filtering unit 640 and the adaptive offset filtering unit 645.

The prediction filtering unit 655 may perform filtering for making a more accurate prediction and may also perform filtering for improving the quality of a reconstructed image.

Like in the encoder, the prediction filtering unit 655 may use a filter represented by the above Equation 1. In this case, the base filter kernel may be information already known to the decoder. However, the present invention is not limited to this, and, for example, the base filter kernel G for each unit configured in the encoder may be transmitted from the encoder or derived from other coding information.

The modulation weight may include at least one of a temporal modulation weight and a spatial modulation weight. In this case, the modulation weight may be information transmitted from the encoder, but the present invention is not limited to this, and, for example, the modulation weight may be information that is derived from other coding information for each configured level or already known to the decoder.

A signal filtered through the prediction filtering unit 655 may be transmitted to the decoded picture buffer 650 and stored for use as a reference picture for inter-prediction.

A filtered signal transmitted to the decoded picture buffer 650 may be transmitted to the prediction filtering unit 655 and re-filtered to improve prediction performance. In this case, the prediction filtering unit 655 may perform a filtering process for minimizing the difference between an original image and a reference image. For example, the prediction filtering unit 655 may perform filtering using a Wiener filter.

As above, a signal filtered through the prediction filtering unit 655 may be transmitted to the prediction unit 660 and used to generate a prediction signal. For example, the signal filtered through the prediction filtering unit 655 may be used as a reference picture by the inter-prediction unit 661. In this way, coding efficiency may be improved by using a filtered picture as a reference picture in the inter-screen prediction mode. Although the prediction filtering unit 655 is illustrated as a separate unit from the prediction unit 660, this is merely an embodiment and the prediction filtering unit 655 may be located within the prediction unit 660 or configured together with other units.

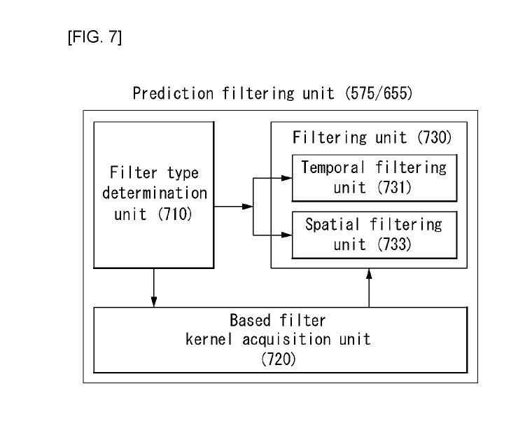

FIG. 7 is a schematic internal block diagram of a prediction filtering unit according to an embodiment to which the present disclosure is applied.

The prediction filtering unit 575/655 may include at least one of a filter type determination unit 710, a base filter kernel acquisition unit 720, and a filtering unit 730. The filtering unit 730 may include a temporal filtering unit 731 and a spatial filtering unit 733. The internal block diagram of FIG. 7 is an embodiment of the present invention, and the units for performing those functions are not limited to the units shown in FIG. 7. For example, the prediction filtering unit 575/655 may include a parameter acquisition unit and a filtering unit.

The filter type determination unit 710 may determine which type of filtering to perform. For example, the filter type determination unit 710 may determine whether to perform temporal filtering or spatial filtering. Although this embodiment exemplifies two types, i.e., temporal filtering and spatial filtering, the present invention is not limited to them and may include the functions of various filters included in the encoder or decoder.

In an embodiment of the present invention, the filter type determination unit 710 may determine which type of filtering to perform based on filtering flag information. For example, the filtering flag information may include a temporal filtering flag and a spatial filtering flag. The temporal filtering flag may indicate whether temporal filtering is being performed, and may be represented by temporal_filtering_enabled_flag, for example. The spatial filtering flag may indicate whether spatial filtering is being performed, and may be represented by spatial_filtering_enabled_flag, for example.

In another example, the filtering flag information may be defined by a single flag. For example, the single flag may be represented by filtering_enabled_flag, and if filtering_enabled_flag is 0, it means that temporal filtering is being performed, and if filtering_enabled_flag is 1, it means that spatial filtering is being performed.

In another example, the present invention may define flag information indicating whether to use a correlation with a spatial filter parameter when coding a temporal filter parameter. Similarly, this may also apply when coding a spatial filter parameter. For example, a temporal filter parameter may be coded, and the difference between a spatial filter parameter and the temporal filter parameter may be coded and transmitted.

In another example, since adjacent blocks may have a similar filter parameter, the use of a filter parameter of an adjacent block may be indicated by a flag to reduce the bit rate. Also, the use of a filter parameter of the block to the left or the use of a filter parameter of the block above may be indicated by a flag. Alternatively, only the difference in the value of a filter parameter between adjacent blocks may be coded and transmitted.

In another embodiment of the present invention, the filter type determination unit 710 may determine which type of filtering to perform based on filter type information. For example, the filter type information may be represented by filter_type, and if filter_type is 0, it means that temporal filtering is to be performed, and if filter_type is 1, it means that spatial filtering is to be performed. Further, filter_type may have a value of 2 or higher, other than 0 and 1, and may be defined such that each value corresponds to a different filtering type.

In another example, the prediction filtering unit may be defined to include all functional units that perform filtering in the encoder or decoder. For example, the prediction filtering unit may include at least one of a deblocking filtering unit, an adaptive offset filtering unit, and an adaptive loop filtering unit. In this case, the prediction filtering unit may perform the function of each filtering unit by using the filter type information.

Meanwhile, the base filter kernel acquisition unit 720 may obtain a base filter kernel for performing filtering. The base filter kernel may be information already known to the encoder and decoder. However, the present invention is not limited to this, and, for example, the base filter kernel for each unit configured in the encoder may be calculated and transmitted to the decoder. Alternatively, the base filter kernel for each unit configured in the encoder and decoder may be derived.

In another example, the base filter kernel may be obtained based on information transmitted from the filter type determination unit 710. For example, when temporal filtering is performed, a first base filter kernel may be obtained, and when spatial filtering is performed, a second base filter kernel may be obtained. Here, the first base filter kernel may indicate a predetermined base filter kernel suitable for temporal filtering, and the second base filter kernel may indicate a predetermined base filter kernel suitable for spatial filtering.

The filtering unit 730 may perform filtering based on at least one of filtering flag information (or filter type information) and a base filter kernel. For example, if the filtering flag information (or filter type information) indicates that temporal filtering is being performed, the temporal filtering unit 731 may calculate a temporal modulation weight C_temporal for minimizing the difference between an original image and a reference image. The temporal filtering unit 731 may perform temporal filtering based on an obtained based filter kernel and the temporal modulation weight C_temporal. Through this process, a predicted image for inter-prediction may be obtained.

In another example, if the filtering flag information (or filter type information) indicates that spatial filtering is being performed, the spatial filtering unit 733 may calculate a spatial modulation weight C_spatial for minimizing the difference between an original image and a reconstructed image. The spatial filtering unit 733 may perform spatial filtering based on an obtained based filter kernel and the spatial modulation weight C_spatial. A spatially filtered, reconstructed image may be stored in the DPB.

Meanwhile, the temporal modulation weight C_temporal and the spatial modulation weight C_spatial may be transmitted from the encoder. Accordingly, in the case of the decoder, the filtering unit 730 may perform temporal filtering upon receiving the temporal modulation weight C_temporal and perform spatial filtering upon receiving the spatial modulation weight C_spatial.

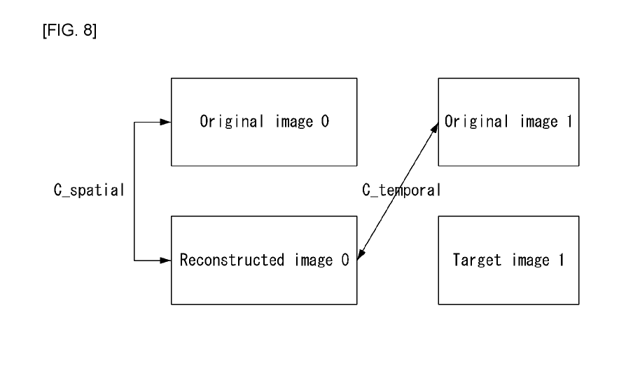

FIG. 8 is a view illustrating a spatial filter parameter and a temporal filter parameter according to an embodiment to which the present disclosure is applied.

The present invention proposes a method of integrating a plurality of filters serving a similar purpose into a single filter. To this end, a spatial filter parameter and a temporal filter parameter are defined.

The spatial filter parameter may refer to a spatial modulation weight C_spatial, and the spatial modulation weight C_spatial indicates a parameter for minimizing the difference between original image 0 and reconstructed image 0.

The temporal filter parameter may refer to a temporal modulation weight C_temporal, and the temporal modulation weight C_temporal indicates a parameter for minimizing the difference between original image 1 and reconstructed image 0. That is, there is a temporal difference between original image 1 and reconstructed image 0, and the temporal modulation weight C_temporal indicates a parameter for minimizing the difference between temporally different images.

Further, since images have high temporal redundancy as well as high spatial redundancy, there is a high possibility that the temporal modulation weight C_temporal and the spatial modulation weight C_spatial have a similar value.

Accordingly, an embodiment of the present invention provides a method for minimizing the bit rate for transmitting a filter parameter, based on the similarity between the temporal modulation weight C_temporal and the spatial modulation weight C_spatial.

For example, a method of transmitting a spatial modulation weight C_spatial and then transmitting the difference between the spatial modulation weight C_spatial and a temporal modulation weight C_temporal may be employed. In this case, the temporal modulation weight C_temporal may be derived using the difference with the spatial modulation weight C_spatial.

Alternatively, a method of transmitting a temporal modulation weight C_temporal and then transmitting the difference between the temporal modulation weight C_temporal and a spatial modulation weight C_spatial may be employed.

This is merely an embodiment, and the same may apply when transmitting other filter parameters than modulation weights.

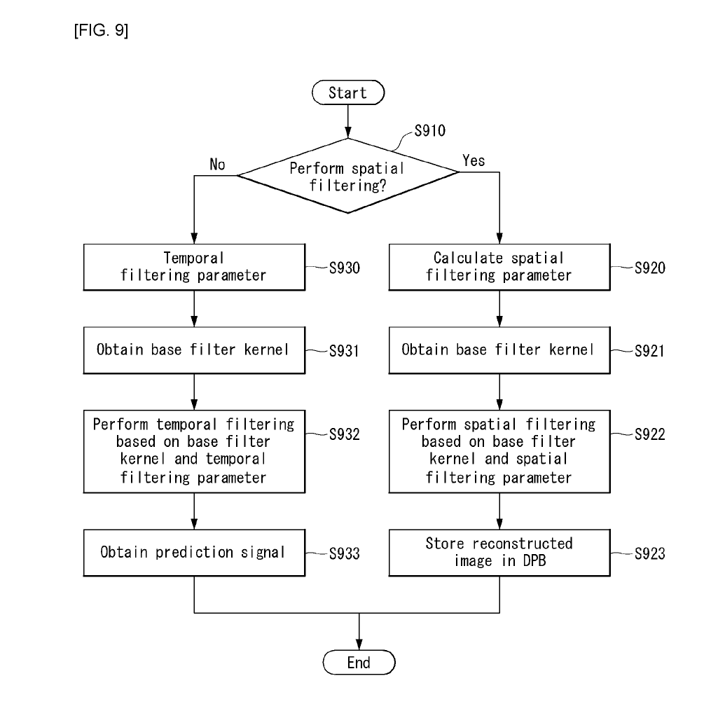

FIG. 9 shows a method of performing prediction filtering based on a spatial filter parameter or temporal filter parameter according to an embodiment to which the present disclosure is applied.

The decoder may determine which type of filtering to perform. For example, the decoder may determine whether to perform temporal filtering or spatial filtering (S910).

In an embodiment of the present invention, the decoder may determine which type of filtering to perform based on filtering flag information. For example, the filtering flag information may include a temporal filtering flag and a spatial filtering flag.

In another example, the filtering flag information may be defined by a single flag. For example, the single flag may be represented by filtering_enabled_flag, and if filtering_enabled_flag is 0, it means that temporal filtering is being performed, and if filtering_enabled_flag is 1, it means that spatial filtering is being performed.

In another embodiment of the present invention, the decoder may determine which type of filtering to perform based on filter type information. For example, the filter type information may be represented by filter_type, and if filter_type is 0, it means that temporal filtering is to be performed, and if filter_type is 1, it means that spatial filtering is to be performed. Further, filter_type may have a value of 2 or higher, other than 0 and 1, and may be defined such that each value corresponds to a different filtering type.

The decoder may calculate a filter parameter corresponding to the determination.

For example, if the filtering flag information (or filter type information) indicates that spatial filtering is being performed, a spatial filter parameter (e.g., spatial modulation weight C_spatial) for minimizing the difference between an original image and a reconstructed image may be calculated (S920).

The decoder may obtain a base filter kernel (S921). The base filter kernel may be information already known to the decoder. However, the present invention is not limited to this, and, for example, the base filter kernel for each unit configured in the decoder may be derived.

The decoder may perform spatial filtering using the base filter kernel and the spatial filter parameter (S922). Then, a spatially filtered, reconstructed image may be stored in the DPB (S923).

In another example, if the filtering flag information (or filter type information) indicates that temporal filtering is being performed, the decoder may calculate a temporal filter parameter (e.g., temporal modulation weight C_temporal) for minimizing the difference between an original image and a reference image (S930).

The decoder may obtain a base filter kernel (S931). The base filter kernel may be information already known to the decoder. However, the present invention is not limited to this, and, for example, the base filter kernel for each unit configured in the decoder may be derived.

The decoder may perform temporal filtering using the base filter kernel and the temporal filter parameter (S932). Through this process, a prediction signal for inter-prediction may be obtained (S933).

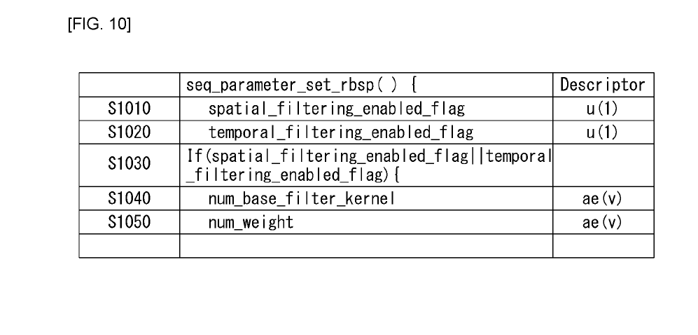

FIG. 10 shows a syntax structure for defining a filter parameter based on filtering flag information at the sequence level according to an embodiment to which the present disclosure is applied.

The present invention proposes a method for signaling filtering flag information and a filter parameter. For example, at least one of the filtering flag information and the filter parameter may be defined at the level of at least one of an SPS (sequence parameter set), a PPS (picture parameter set), a slice, a CU (coding unit), a PU (prediction unit), a block, a polygon, and a process unit.

The above FIG. 10 shows a syntax structure for defining filtering flag information and a filter parameter in an SPS (sequence parameter set) among the above examples.

First of all, the filtering flag information may include a temporal filtering flag and a spatial filtering flag. The spatial filtering flag may be represented by spatial_filtering_enabled_flag (S1010), and the temporal filtering flag may be represented by temporal_filtering_enabled_flag (S1020).

If the spatial filtering flag or the temporal filtering flag is 1, that is, spatial filtering or temporal filtering is being performed (S1030), a filter parameter may be obtained. The filter parameter may include at least one of number information (S1040) of a base filter kernel and number information (S1040) of a modulation weight.

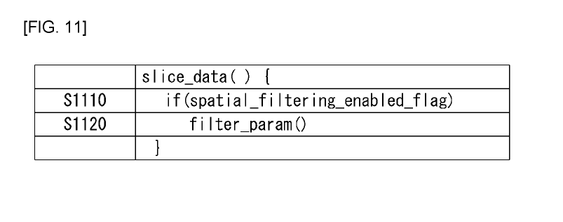

FIG. 11 shows a syntax structure for defining a filter parameter at the slice level according to an embodiment to which the present disclosure is applied.

The present invention proposes a method for signaling a filter parameter. For example, the filter parameter may be defined at the level of at least one of an SPS (sequence parameter set), a PPS (picture parameter set), a slice, a CU (coding unit), a PU (prediction unit), a block, a polygon, and a process unit.

The above FIG. 11 shows a syntax structure for defining a filter parameter at the slice level among the above examples.

For example, if the spatial filtering flag is 1, that is, spatial filtering is being performed (S1110), a filter parameter may be obtained. The filter parameter may include a plurality of parameters, and may be represented by a function filter_param( ) (S1120). The function filter_param( ) may include parameters related to spatial filtering. For example, the function filter_param( ) may include at least one of a base filter kernel for performing spatial filtering and a modulation weight.

Likewise, if the temporal filtering flag is 1, that is, temporal filtering is being performed, a filter parameter may be obtained.

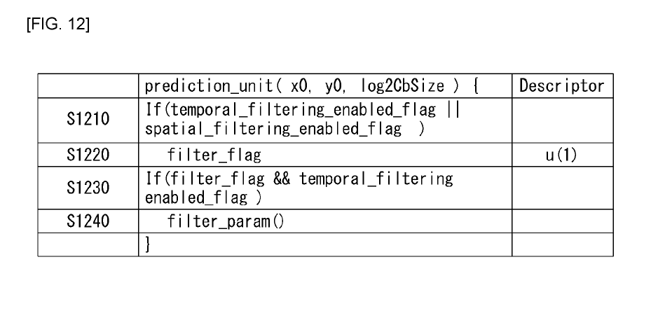

FIG. 12 shows a syntax structure for defining a filter parameter based on filtering flag information for each PU (prediction unit) according to an embodiment to which the present disclosure is applied.

The present invention proposes a method for signaling filtering flag information and a filter parameter at the PU (prediction unit) level. For example, once a temporal filtering flag and a spatial filtering flag are defined at the SPS (sequence parameter set) level, then a PU filter flag indicating whether to perform at the PU (prediction unit) level may be defined.

In the present invention, whether to perform filtering for a corresponding PU may be determined based on the temporal or spatial filtering flag and the PU filter flag, and a filter parameter may be obtained for the corresponding PU according to the determination.

Referring to FIG. 12, if the temporal filtering flag or the spatial filtering flag is 1, that is, temporal filtering or spatial filtering is being performed (S1210), a PU filter flag filter_flag indicating whether to perform filtering for the corresponding PU may be obtained (S1220).

If the PU filter flag indicates that filtering is to be performed for the corresponding PU, and the temporal filtering flag indicates that temporal filtering is being performed (S1230), a filter parameter may be obtained. In this case, the filter parameter may include a plurality of parameters, and may be represented by a function filter_param( ) (S1240). The function filter_param( ) may include parameters related to temporal filtering. For example, the function filter_param( ) may include at least one of a base filter kernel for performing temporal filtering and a modulation weight.

Likewise, if the PU filter flag and the spatial filtering flag are 1, the decoder may obtain a filter parameter for performing spatial filtering for the corresponding PU.

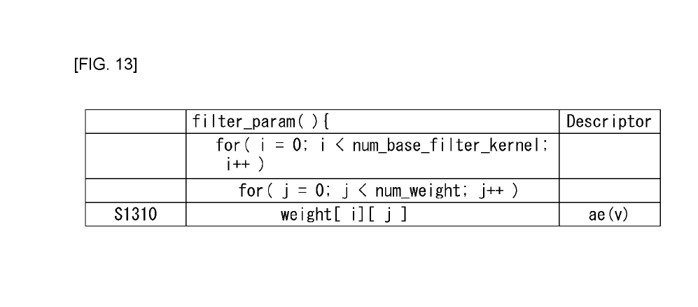

FIG. 13 shows a syntax structure for defining a filter parameter according to an embodiment to which the present disclosure is applied.

The present invention proposes a filter parameter. The filter parameter may include a plurality of parameters, and may be represented by a function filter_param( ). The filter parameter may include at least one of number information of a base filter kernel, number information of a modulation weight, a base filter kernel, and a modulation weight. Moreover, the filter parameter may be defined at the level of at least one of an SPS (sequence parameter set), a PPS (picture parameter set), a slice, a CU (coding unit), a PU (prediction unit), a block, a polygon, and a process unit.

In an embodiment of the present invention, referring to FIG. 13, the decoder may obtain a modulation weight based on at least one of number information of a base filter kernel and number information of a modulation weight (S1310). For example, as many modulation weights as the number information of a modulation weight, corresponding to each base filter kernel, may be obtained.

The decoder may perform filtering using the obtained modulation weights.

As described above, the embodiments explained in the present invention may be implemented and performed on a processor, a micro-processor, a controller or a chip. For example, functional modules explained in FIG. 1 to FIG. 3 and FIG. 5 to FIG. 7 may be implemented and performed on a computer, a processor, a microprocessor, a controller or a chip.

As described above, the decoder and the encoder to which the present disclosure is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional 3D video apparatus, a teleconference video apparatus, and a medical video apparatus and may be used to code video signals and data signals

Furthermore, the decoding/encoding method to which the present disclosure is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves, e.g., transmission through the Internet. Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1. A method for decoding a video signal, comprising:
obtaining filtering flag information indicating whether to perform filtering for a target unit;
obtaining a filter parameter based on the filtering flag information, the filter parameter including at least one of a base filter kernel and a modulation weight; and
performing filtering for the target unit using the filter parameter,
wherein the filter parameter corresponds to a temporal filter parameter or a spatial filter parameter, and
wherein the temporal filter parameter is used to minimize the difference between an original image and a reference image, and the spatial filter parameter is used to minimize the difference between the original image and a reconstructed image.

2. The method of claim 1,
wherein the filtering flag information includes at least one of a temporal filtering flag and a spatial filtering flag, and
wherein the filter parameter corresponds to the filtering flag information.

3. The method of claim 2,
wherein, when the filtering flag information indicates the temporal filtering flag, the filter parameter indicates the temporal filter parameter, and a filtered target unit is used as a prediction signal for inter-prediction.

4. The method of claim 2,
wherein, when the filtering flag information indicates the spatial filtering flag, the filter parameter indicates the spatial filter parameter, and a filtered target unit is stored in a buffer.

5. The method of claim 1, further comprising
obtaining a base parameter based on the filtering flag information,
wherein the filtering flag information is obtained from a sequence parameter set, and the base parameter includes at least one of number information of a base filter kernel and number information of a modulation weight.

6. The method of claim 1,
wherein the base filter kernel is a predetermined value in the decoder.

7. The method of claim 1,
wherein the filtering flag information is obtained from at least one of a sequence parameter set, a picture parameter set, a slice, a coding unit, a prediction unit, or a block.

8. An apparatus for decoding a video signal, comprising:
a filter type determination unit that obtains filtering flag information indicating whether to perform filtering for a target unit;
a filter parameter acquisition unit that obtains a filter parameter based on the filtering flag information; and
a filtering unit that performs filtering for the target unit using the filter parameter,
wherein the filter parameter includes at least one of a base filter kernel and a modulation weight,
wherein the filter parameter corresponds to a temporal filter parameter or a spatial filter parameter, and
wherein the temporal filter parameter is used to minimize the difference between an original image and a reference image, and the spatial filter parameter is used to minimize the difference between the original image and a reconstructed image.

9. The apparatus of claim 8,
wherein the filtering flag information includes at least one of a temporal filtering flag and a spatial filtering flag, and
wherein the filter parameter corresponds to the filtering flag information.

10. The apparatus of claim 9,
wherein, when the filtering flag information indicates the temporal filtering flag, the filter parameter indicates the temporal filter parameter, and a filtered target unit is used as a prediction signal for inter-prediction.

11. The apparatus of claim 9,
wherein, when the filtering flag information indicates the spatial filtering flag, the filter parameter indicates the spatial filter parameter, and a filtered target unit is stored in a buffer.

12. The apparatus of claim 8,
wherein the parameter acquisition unit obtains a base parameter based on the filtering flag information,
wherein the filtering flag information is obtained from a sequence parameter set, and
wherein the base parameter includes at least one of number information of a base filter kernel and number information of a modulation weight.

13. The apparatus of claim 8,
wherein the base filter kernel is a predetermined value in the decoder.

14. The apparatus of claim 8,
wherein the filtering flag information is obtained from at least one of a sequence parameter set, a picture parameter set, a slice, a coding unit, a prediction unit, or a block.
